(19) United States
(12) Patent Application Publication
(10) Pub. No.: US 2025/0334400 A1
(43) Pub. Date: Oct. 30, 2025

(54) SLIT-ADJUSTABLE SUBSTRATE ASSISTED X-RAY LEAKAGE METHOD FOR ULTRATHIN FILM THICKNESS DETECTION DEVICE AND MEASUREMENT METHOD USING THE SAME

(71) Applicant: INDUSTRIAL TECHNOLOGY RESEARCH INSTITUTE, Hsinchu (TW)

(72) Inventors: Shih-Jia SHEN, Taichung City (TW); Yu-Hsin WU, Hsinchu City (TW); Wei-En FU, Taoyuan City (TW); Wen-Li WU, Hsinchu City (TW)

(73) Assignee: INDUSTRIAL TECHNOLOGY RESEARCH INSTITUTE, Hsinchu (TW)

(21) Appl. No.: 19/191,627

(22) Filed: Apr. 28, 2025

(30) Foreign Application Priority Data
Apr. 29, 2024 (TW) 113115976

(51) Int. Cl. G01B 15/02

(52) U.S. Cl. CPC G01B 15/02

(57) ABSTRACT

A measurement device is configured to measure a thickness of a target ultrathin film on the substrate. The measurement device includes a radiation source, a fluorescence X-ray detector and a slit adjustable device. The radiation source is disposed relative to an upper surface of the target ultrathin film and is configured to project an excitation radiation toward the upper surface with an incident angle, wherein the excitation radiation excites fluorescence X-ray from the substrate. The fluorescence X-ray detector is configured to detect the fluorescence X-ray. The slit adjustable device includes a slit element and an adjustment mechanism. The slit element has a slit. The adjustment mechanism is connected to the slit element and configured to adjust a position of the slit of the slit element along a first axis.

This application claims the benefit of Taiwan application Serial No. 113115976, filed Apr. 29, 2024, the disclosure of which is incorporated by reference herein in its entirety.

### TECHNICAL FIELD

The disclosure relates generally to a measurement device and a measurement method for measuring a thickness of an ultrathin film.

### BACKGROUND

The semiconductor integrated circuit (IC) industry has experienced rapid growth. Technological advances in IC materials and design have produced generations of ICs. Each generation has smaller and more complex circuits than the previous generation. In the course of IC evolution, functional density (i.e., the number of interconnected devices per chip area) has generally increased while geometric size (i.e., the smallest component (or line) that may be created using a fabrication process) has decreased. This scaling-down process generally provides benefits by increasing production efficiency and lowering associated costs. However, these advances have increased the complexity of processing and manufacturing ICs. Since feature sizes continue to decrease, fabrication and measurement processes continue to become more difficult to perform.

In the past, common methods for detecting film thickness are X-ray reflectivity (XRR) and X-ray fluorescence (XRF) [1], but the measurement of the target ultrathin film encountered some challenges. The XRR technique has the disadvantage of high noise ratio resulted from the high detecting angle required for measuring the thickness of the thin film thinner than about 1 nm. The XRF technique has the disadvantage of long measurement time due to the minuscular sample volume, hence, weak fluorescence signals for films thinner than about 1 nm. In addition, standard samples of known thickness need to be prepared, measured and then to establish calibration curves for the XRF measurement for thin film thickness.

Therefore, a novel measurement technique satisfying requirements of both high efficiency and non-destructive is needed.

### SUMMARY

According to an embodiment, a measurement device for measuring a thickness of a target ultrathin film on a substrate is provided. The measurement device includes a radiation source, a fluorescence X-ray detector and a slit adjustable device. The radiation source is disposed opposite to an upper surface of the target ultrathin film and configured to project an excitation radiation toward the upper surface with an incident angle, wherein the excitation radiation excites a fluorescence X-ray from the substrate. The fluorescence X-ray detector is configured to detect the fluorescence X-ray. The slit adjustable device includes a slit element and an adjustment mechanism. The slit element has a slit. The adjustment mechanism is connected to the slit element and configured to adjust a position of the slit of the slit element along a first axis.

According to another embodiment, a measurement method for measuring a thickness of a target ultrathin film on a substrate is provided. The measurement method includes the following steps: projecting an excitation radiation with an incident angle toward an upper surface of the target ultrathin film, wherein the excitation radiation excites a fluorescence X-ray from the substrate; adjusting a position of a slit of a slit element along a first axis by an adjustment mechanism of a slit adjustable device; and detecting the fluorescence X-ray traveling through the slit by a fluorescence X-ray detector.

### BRIEF DESCRIPTION OF THE DRAWINGS

FIG. 1A shows a schematic diagram of a measurement device 100 according to an embodiment of the present disclosure;

FIG. 1B shows a schematic diagram of an elevation view of the measurement device 100 in FIG. 1A;

FIG. 2 shows a schematic diagram of an elevation view of a slit adjustable device 130 in FIG. 1A;

FIGS. 3A to 3C show schematic diagrams of the measurement device 100 in FIG. 1A measuring a test sample 10;

FIG. 4 shows a schematic diagram of a curve showing the relationship between a grazing detection angle range and a fluorescence intensity of an target ultrathin film of different thicknesses; and

FIG. 5 shows a flow chart of a measuring method of the measurement device 100 in FIG. 1A.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

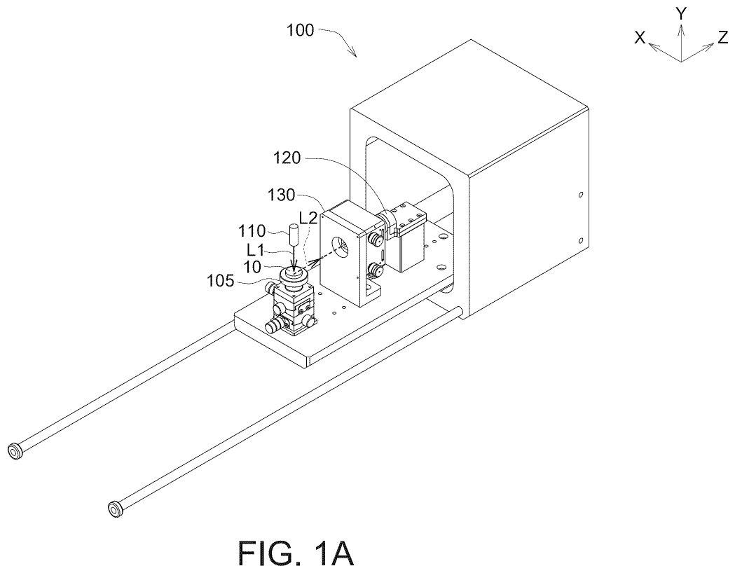

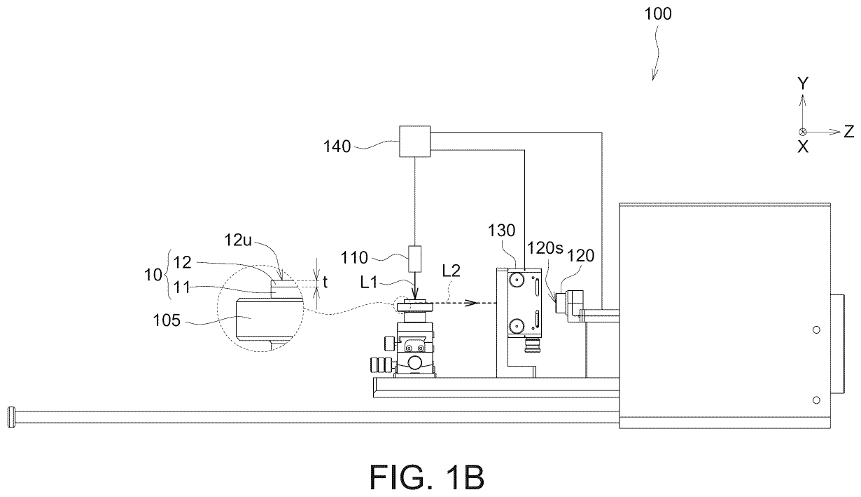

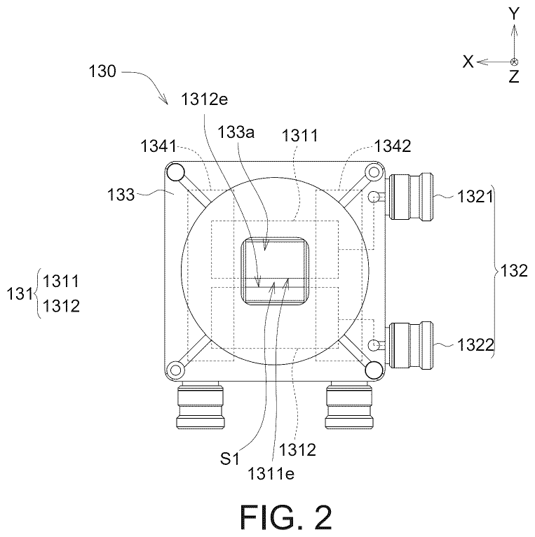

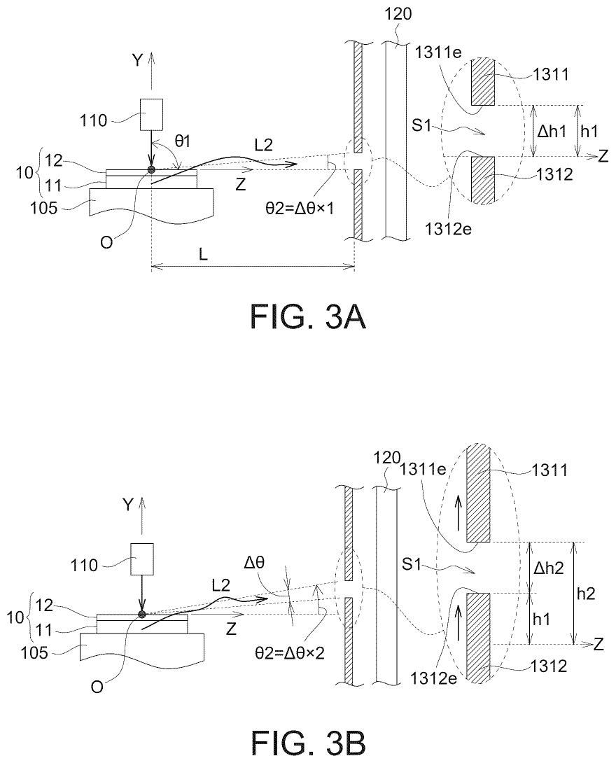

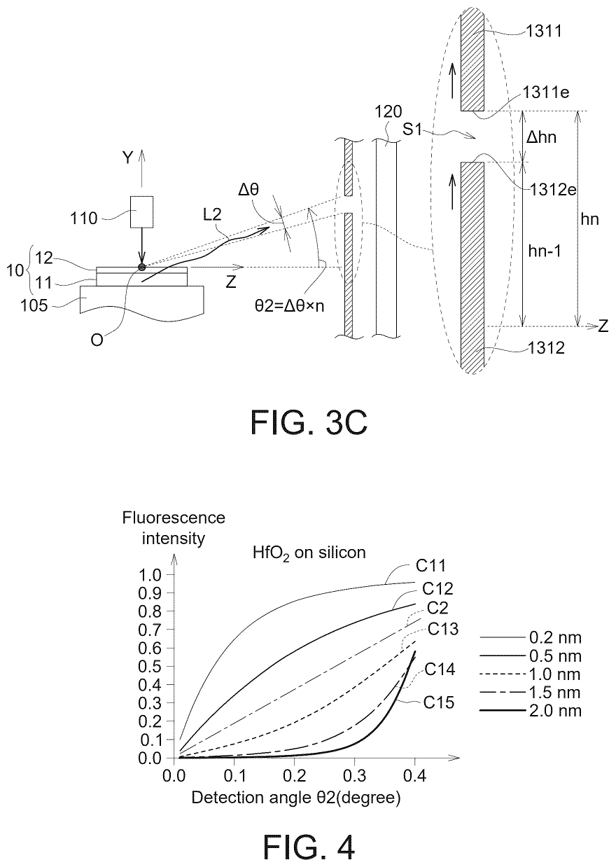

Referring to FIGS. 1A to 4, FIG. 1A shows a schematic diagram of a measurement device 100 according to an embodiment of the present disclosure, FIG. 1B shows a schematic diagram of an elevation view of the measurement device 100 in FIG. 1A, FIG. 2 shows a schematic diagram of a front view of a slit adjustable device 130 in FIG. 1A, FIGS. 3A to 3C show schematic diagrams of the measurement device 100 in FIG. 1A measuring a test sample 10, and FIG. 4 shows a schematic diagram of a curve showing the relationship between a grazing detection angle range and a fluorescence intensity of an target ultrathin film 12 of different thicknesses.

As shown in FIGS. 1A and 1B, the measurement device 100 is, for example, a slit-adjustable substrate assisted measurement device for ultrathin film thickness, which is configured to measure a thickness t of a target ultrathin film 12 on a substrate 11. The measurement device 100 includes a stage 105, a radiation source 110, a fluorescence X-ray detector 120, the slit adjustable device 130 and a controller 140. The radiation source 110 is disposed with respect to an upper surface 12u of the target ultrathin film 12 and is configured to: project an excitation radiation L1 toward the upper surface 12u with an incident angle θ1, wherein the excitation radiation L1 excites the substrate 11 to generate fluorescence X-rays L2, and the fluorescence X-rays L2 are radiated after leaking or tunneling through the upper target ultrathin film. The fluorescence X-ray detector 120 is configured to detect the fluorescence X-ray L2. As shown in FIG. 2, the slit adjustable device 130 includes a slit element 131 and an adjustment mechanism 132, wherein the slit element 131 has a slit S1, and the adjustment mechanism 132 is connected to the slit element 131 and is configured to adjust a position of the slit S1 of the slit element 131 along the first axis Y (for example, +/−Y direction). Thus, by controlling the position of the slit S1, the signal (for example, intensity value) of the fluorescence X-ray L2 at different positions within a range of the grazing detection angle θ2 (shown in FIGS. 3A to 3C) may be detected. In an embodiment, since the slit S1 only performs translational motion (for example, no rotational motion), a rotational mechanism (for example, components such as a motor and a rotation arm for providing rotational motion) may be omitted.

As shown in FIG. 1B, the test sample 10 includes a substrate 11 and the target ultrathin film 12. The method disclosed herein is a substrate assisted X-ray leakage (SAXRL) method for the measurement of the target ultrathin film thickness. The thickness of the target ultrathin film 12 is measured from the intensities of the fluorescence X-ray L2 (i.e. the fluorescence X-ray intensities) converted by the substrate 11 and leaking or tunneling through the target ultrathin film 12 at various detection angle, such as the grazing detection angle θ2. The fluorescence X-ray L2 generated from the substrate 11 has sufficient and stable high intensity due to an ample substrate thickness about a millimeter instead of a few nanometers for the target thin film, therefore, may provide fluorescence signal strong enough to make the measurement performed rapidly and precisely. The method and the device disclosed herein may be used to measuring the thickness of a few nanometers (nm) or less of the target ultrathin film 12. The thickness of the target ultrathin film 12 which may be measured by the method and the device disclosed herein may be 0.2 nanometer (nm) to 2 nm. It is preferred that the X-ray scattering length density (SLD) of the target ultrathin film 12 is higher than the X-ray scattering length density of the substrate 11 below the target ultrathin film 12. The abovementioned substrate 11 may include a single material layer including a silicon wafer, a GaAs wafer, a InP wafer and/or other commonly encountered substrates, and the target ultrathin film 12 includes a single material layer, as shown in FIG. 1B. Otherwise, the substrate 11 can include multiple layers of different materials, and the target ultrathin film 12 includes a single material layer. Alternatively, the target ultrathin film 12 may include multiple layers of different materials. The abovementioned fluorescence X-ray L2 includes the fluorescence X-ray from the substrate 11 including one or more layers. The target ultrathin film 12 and the substrate 11 may include semiconductor materials, but are not limited thereto.

In an embodiment, the substrate 11 is, for example, a Si substrate, a GaAs substrate, a GaAs substrate, an InP substrate or an InP substrate. The target ultrathin film 12 is, for example, a semiconductor thin film, such as TaN, TiN, HfO₂, etc., which is formed by at least one semiconductor process.

As shown in FIG. 1B, the stage 105 is configured to carry the test sample 10.

As shown in FIG. 1B, a preferred range of the incident angle θ1 ranges between 45° and 90°. The value of the incident angle θ1 may be close to 90°, that is, close to a normal incident direction. The excitation radiation L1 includes an X-ray beam or an electron beam having a sufficiently high energy to excite the desired fluorescence X-rays L2 from one or more preselected substrate layers in the substrate 11.

As shown in FIG. 1B, the fluorescence X-ray detector 120 is disposed, for example, opposite to the slit adjustable device 130 to receive the fluorescence X-ray L2 leaking from the target ultrathin film 12 within the range of the grazing detection angle θ2. For example, the fluorescence X-ray detector 120 has a light incident surface 120s, which may face the slit S1 (the slit S1 is shown in FIG. 2) of the slit adjustable device 130 to receive the fluorescence X-ray L2 that travels through the slit S1.

The fluorescence X-ray detector 120 is capable of discerning energies and/or wavelengths of the observed fluorescence X-ray, thereby collecting the intensities of all selected fluorescence energies and/or wavelengths. The fluorescence X-ray intensities (i.e., the intensities of the fluorescence X-ray L2) are detected with a plurality of the grazing detection angles θ2. The fluorescence X-ray detector 120 is capable of measuring a distribution of the fluorescence X-ray intensity (or the intensity distribution) as a function of the fluorescence wavelength or energy; thereby to selectively/concurrently measure the intensity (or the fluorescence X-ray intensities) originated from certain layers (e.g. one or more layers) and/or certain elements (e.g. one or more elements) including the substrate 11, or from certain elements of a compound substrate such as InP, GaAs and/or others.

As shown in FIG. 1B, the slit adjustable device 130 is disposed between the stage 105 and the fluorescence X-ray detector 120. As a result, the fluorescence X-ray L2 may travel through the slit S1 and be incident into the fluorescence X-ray detector 120, so that the fluorescence X-ray detector 120 receives the fluorescent intensity of the fluorescence X-ray L2.

As shown in FIG. 2, the slit element 131 includes a first movable element 1311 and a second movable element 1312. The second movable element 1312 is disposed opposite to the first movable element 1311. For example, the second movable element 1312 and the first movable element 1311 are disposed along the first axis Y The slit S1 is spaced between the first movable element 1311 and the second movable element 1312. For example, the first movable element 1311 has a first lateral edge 1311e, and the second movable element 1312 has a second lateral edge 1312e. The first lateral edge 1311e and the second lateral edge 1312e are opposite to each other and spaced apart to form the slit S1. A distance between the first lateral edge 1311e and the second lateral edge 1312e defines a width of the slit S1.

As shown in FIG. 2, the adjustment mechanism 132 may control the movement of the slit element 131 through rotation, translation or a combination thereof to change the width and/or the position of the slit S1. For example, the adjustment mechanism 132 includes a first adjustment element 1321 and a second adjustment element 1322. The first adjustment element 1321 may be directly or indirectly connected to the first movable element 1311 to drive the first movable element 1311 to move along the first axis Y (for example, +/−Y direction). The second adjustment element 1322 may be directly or indirectly connected to the second movable element 1312 to drive the second movable element 1312 to move along the first axis Y (for example, +/−Y direction). In an embodiment, the first movable element 1311 and the second movable element 1312 may move synchronously in the same direction to maintain the width of the slit S1 (the width remains unchanged). In another embodiment, the first movable element 1311 and the second movable element 1312 may move in opposite directions respectively to change the width of the slit S1.

In an embodiment, the adjustment mechanism 132 further includes a first gear and a first rack that are meshed with each other, the first adjustment element 1321 is connected to the first gear (for example, the first adjustment element 1321 has a gear that meshes with the first gear), and the first movable element 1311 is connected to the first rack. When the first adjustment element 1321 rotates, the first gear may be driven to rotate, so as to drive the first rack to move along the first axis Y, thereby driving the first movable element 1311 to move along the first axis Y Similarly, the adjustment mechanism 132 further includes a second gear and a second rack meshing with each other, the second adjustment element 1322 is connected to the second gear (for example, the second adjustment element 1322 has a gear meshing with the second gear), and the second movable element 1312 is connected to the second rack. When the second adjustment element 1322 rotates, the second gear may be driven to rotate, so as to drive the second rack to move along the first axis Y, thereby driving the second movable element 1312 to move along the first axis Y In an embodiment, the first adjustment element 1321 and the second adjustment element 1322 may rotate synchronously in the same direction to drive the first movable element 1311 and the second movable element 1312 to move synchronously in the same direction.

In addition, although not shown, the adjustment mechanism 132 further includes a first driver and a second driver. The first driver connects the first adjustment element 1321 with the controller 140, and the second driver connects the second adjustment element 1322 with the controller 140. The controller 140 is configured to control the first driver to drive the first adjustment element 1321 to operate and control the second driver to drive the second adjustment element 1322 to operate. In an embodiment, the first driver and/or the second driver is, for example, a motor.

As shown in FIG. 2, the slit adjustable device 130 may further include a body 133, a third adjustment element 1341 and a fourth adjustment element 1342. The first adjustment element 1321, the second adjustment element 1322, the third adjustment element 1341 and the fourth adjustment element 1342 may be disposed in the main body 133. The body 133 has an opening 133a which exposes the slit S1. The fluorescence X-ray L2 is incident into the fluorescence X-ray detector 120 through the opening 133a and the slit S1. The third adjustment element 1341 and the fourth adjustment element 1342 are disposed along the third axis X, and a distance between the third adjustment element 1341 and the fourth adjustment element 1342 may define a length of the slit S1 along the third axis X.

As shown in FIG. 1B, the controller 140 is electrically connected to the radiation source 110, the fluorescence X-ray detector 120 and the slit adjustable device 130 to control these elements. For example, the controller 140 may control the radiation source 110 to project the excitation radiation L1. The controller 140 may receive the detection signal of the fluorescence X-ray detector 120 to analyze (or calculate) the received detection signal to obtain the thickness t of the target ultrathin film 12. The controller 140 may control the adjustment mechanism 130 to drive the slit S1 to move along the first axis Y. For example, the controller 140 may control the first adjustment element 1321 of the adjustment mechanism 132 to rotate and/or the second adjustment element 1322 to rotate, so as to drive the slit S1 to move along the first axis Y.

As shown in FIGS. 3A to 3C, the slit S1 may move along the first axis Y to receive signals of the fluorescence X-ray L2 at different positions within the range of the grazing detection angle θ2, and such process may be called “scanning”. During the scanning process, the radiation source 110 continuously emits the excitation radiation L1, and the fluorescence X-ray detector 120 continuously receives the fluorescence X-ray L2 that travels through the slit S1, until the scanning is completed (for example, the detection curve C2 in FIG. 4 is obtained).

Referring to FIGS. 3A to 3C, the width Δhₙ of the slit S1 in each scanning step may be obtained by the following formulas (1) to (3). Formula (1) is applicable to the case where n=1, while formula (3) is applicable to the case where n≥2. In formulas, Δθ represents the step angle (the step angle of the detection angle range of each scan, or may be called a feed angle), “n” represents the n^{th} scanning step, and “n” is a positive integer between 1 and N, where “N” is the number of the scanning steps, and the value of “N” is a positive integer equal to or greater than 1. “L” represents a distance between the target ultrathin film 12 and the slit S1 along the second axis Z (for example, a projection size of the distance between the origin O of the coordinate system XYZ and the slit S1 onto the second axis Z), wherein the second axis Z is substantially perpendicular to the first axis Y, h₁ represents a stroke height (for example, the size along the first axis Y) of the slit S1 in the first scanning step, hₙ represents a stroke height of the slit S1 in the n^{th} scanning step, and Δhₙ is a width of the slit S1 in the n^{th} scanning step.

$${h}_{1} = Δ {h}_{1} = L \cdot tan ( Δθ ) \qquad ( 1 )$$

$${h}_{n} = L \cdot tan ( Δθ \times n ) \qquad ( 2 )$$

$$Δ {h}_{n} = {h}_{n} - {h}_{n - 1} \qquad ( 3 )$$

As shown in FIG. 3A, in the first scanning step (n=1), the second lateral edge 1312e of the second movable element 1312 is located at a position where a stroke height (for example, first axis Y) is zero, and the first lateral edge 1311e of the first movable element 1311 is located at a position where a stroke height (for example, first axis Y) is h₁. The stroke height h₁ and the width Δh₁ of the slit S1 along the first axis Y are obtained by formula (1). In the first scanning step, the stroke height h₁ of the slit S1 is defined to be substantially equal to the width Δh₁.

As shown in FIG. 3B, in the second scanning step (n=2), the width Δh₂ of the slit S1 along the first axis Y is obtained by formulas (2) and (3). For example, the stroke height h₂ in the second scanning step is first obtained by formula (2), and then the difference between the stroke height h₂ in the second scanning step (e.g., the current scanning step) and the stroke height h₁ in the first scanning step (e.g., the previous scanning step) is obtained by formula (3). This difference is the width Δh₂ of the slit S1 required for the second scanning step.

After the width Δh₂ is obtained, the width of the slit S1 may be controlled to be the width Δh₂ by moving the first movable element 1311 and/or the second movable element 1312. For example, the second movable element 1312 may move along the first axis Y (for example, along the +Y direction) until the second lateral edge 1312e of the second movable element 1312 is located at the stroke height h₁, and the first movable element 1311 may move along the first axis Y (for example, along the +Y direction) until the first lateral edge 1311e of the first movable element 1311 is located at the stroke height h₂. As a result, the width Δh₂ of the slit S1 required for the second scanning step may be obtained.

As shown in FIG. 3C, in the n^{th} scanning step (n≥3), the width Δhₙ of the slit S1 required for the n^{th} scanning step may be obtained by the method similar to that of the second scanning step described above. Then, the width of the slit S1 may be controlled to be the width Δhₙ through the movement of the first movable element 1311 and/or the second movable element 1312.

In an embodiment, the number of scanning steps N may be a positive integer between 1 and 10 or between 11 and 20, or may be greater. The range of the grazing detection angle θ2 (i.e., Δθ×1 to Δθ×N) may be a real number between 0 and 2 degrees (including valves of the end points), but may also be greater than 2 degrees. For example, if N is equal to 10 and the range of the grazing detection angle θ2 is equal to 2 degrees, the grazing detection angle θ2 is 0.2 degrees, that is, in each scanning step, the grazing detection angle θ2 increases by 0.2 degrees. When the range of the grazing detection angle θ2 is within 2 degrees and the detection is to be completed with 10 scanning steps, the width of the slit S1 is gradually controlled to be Δh₁, Δh₂, Δh₃, Δh₄, Δh₅, Δh₆, Δh₇, Δh₈, Δh₉ and Δh₁₀ as the scanning steps are accumulated, and the values may be obtained by the controller 140 according to the above formulas (1) to (3).

In addition, as shown in FIGS. 3A to 3C, the scanning direction is, for example, the +Y direction, i.e., the direction from the low grazing detection angle to the high grazing detection angle. In another embodiment, depending on the requirements, during the scanning process, the scanning direction includes, for example, +Y direction, −Y direction (i.e., a direction from a high grazing detection angle to a low grazing detection angle) or a combination thereof.

The range of the grazing detection angle θ2 is chosen to be less than or comparable to the critical angle of substrate/thin film pairs commonly encountered in IC applications. The critical angle of an interface is dictated by the scattering length density of the materials across the interface as well as the wavelength of the substrate fluorescence X-ray. At the grazing detection angle θ2 less than the substrate/thin film critical angle, the fluorescence X-ray originated from the substrate can leak through the thin film of a few nanometers thick or less; whereas as the grazing detection angle θ2 becomes greater than the substrate/thin film critical angle, a majority of the fluorescence X-ray will leak through the thin film regardless of the film thickness, hence, renders a drop in its sensitivity of measuring film thickness. The abovementioned fluorescence X-ray detector 120 is capable of collecting fluorescence X-ray L2 over a range of energies or wavelengths simultaneously and quantifying the intensity distribution of the observed fluorescence X-ray L2 over the energy or wavelength window of interests.

As shown in FIG. 4, the horizontal axis represents the range of the grazing detection angle θ2, and the vertical axis represents the fluorescence intensity (for example, the normalized intensity (i.e., the maximum intensity is value 1)) detected by the fluorescence X-ray detector 120. FIG. 4 is a diagram showing a simulation for a target ultrathin film consisting of HfO₂ on a silicon substrate, wherein the thickness of the target ultrathin film HfO₂ is 0.2 nm (curve C11), 0.5 nm (curve C12), 1.0 nm (curve C13), 1.5 nm (curve C14) and 2.0 nm (curve C15).

After the measurement device 100 detects the fluorescence intensity of each scanning step for the target ultrathin film 12, a detection curve C2 of the corresponding grazing detection angle range and fluorescence intensity of the target ultrathin film 12 may be obtained. The controller 140 may obtain the thickness t (thickness t is shown in FIG. 1B) of the target ultrathin film 12 according to (analyzing or calculating) the relationship curve between the grazing detection angle range and the fluorescence intensity as shown in FIG. 4.

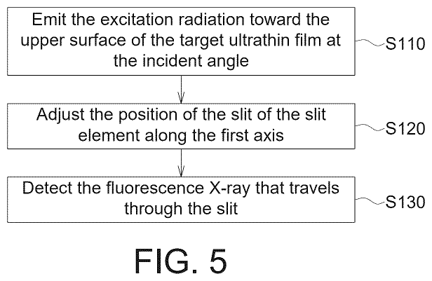

Referring to FIG. 5, FIG. 5 shows a flow chart of a measuring method of the measurement device 100 in FIG. 1A.

In step S110, as shown in FIGS. 1A and 1B, the radiation source 110 project the excitation radiation L1 at an incident angle θ1 toward the upper surface 12u of the target ultrathin film 12, wherein the excitation radiation L1 excites the substrate 11 to generate fluorescence X-rays L2. In an embodiment, the controller 140 may control the radiation source 110 to project the excitation radiation L1 at the incident angle θ1 toward the upper surface 12u of the target ultrathin film 12.

In step S120, the adjusting mechanism 132 of the slit adjustable device 130 adjusts the position of the slit S1 of the slit element 131 along the first axis Y In an embodiment, the controller 140 controls the movement of the adjustment mechanism 132 to drive the width and/or the position of the slit S1 of the slit element 131. The movement of the adjustment mechanism 132 has been stated above, and it will not be repeated herein.

In step S130, the fluorescence X-ray detector 120 detects the fluorescence X-ray L2 that travels through the slit S1.

In an embodiment, in each scanning step, step S110, step S120 and step S130 may be performed simultaneously. In another embodiment, in each scanning step, during the process of adjusting the position of the slit S1 of the slit element 131 along the first axis Y (for example, the process of moving the slit S1 in FIG. 3A to the slit S1 in FIG. 3B), the radiation source 110 does not project the radiation source L1. After the position of the slit S1 is adjusted and completed (for example, the width and the position of the slit S1 shown in FIG. 3B), the radiation source 110 projects the radiation source L1 again.

In summary, the disclosed embodiments provide a measurement device and a measuring method, which may adjust the geometric parameters of the slit (for example, a width, a length and/or a position, etc.) by using a slit adjustable device to allow the fluorescence X-rays to travel through the slit at different grazing detection angles. In an embodiment, the slit is translatable along a straight line. In an embodiment, the slit may be formed through a gap between the two movable elements. Due to the slit only performing translational motion (for example, no rotational motion), a rotation mechanism (for example, a motor, a rotation arm, etc.) may be omitted.

It will be apparent to those skilled in the art that various modifications and variations may be made to the disclosed embodiments. It is intended that the specification and examples be considered as exemplars only, with a true scope of the disclosure being indicated by the following claims and their equivalents.

What is claimed is:

1. A measurement device for measuring a thickness of an target ultrathin film on a substrate, and the measurement device comprises:
a radiation source, disposed opposite to an upper surface of the target ultrathin film and configured to:
project an excitation radiation toward the upper surface with an incident angle, wherein the excitation radiation excites a fluorescence X-ray from the substrate;
a fluorescence X-ray detector, configured to detect the fluorescence X-ray; and
a slit adjustable device, comprising:
a slit element, having a slit for allowing the fluorescence X-ray to travel through; and
an adjustment mechanism, connected to the slit element and configured to adjust a position of the slit of the slit element along a first axis;
wherein in a first scanning step, the slit has a width along the first axis, and the width is determined using formula (1):
$${h}_{1} = Δ {h}_{1} = L \cdot tan ( Δθ ) ; \qquad ( 1 )$$
wherein Δθ represents a step angle, L represents a distance between the slit and the target ultrathin film along a second axis substantially perpendicular to the first axis, h₁ represents a stroke height of the slit during the first scanning step, and Δh₁ represents the width of the slit in the first scanning step.

2. The measurement device according to claim 1, wherein the slit element comprises:
a first movable element; and
a second movable element, disposed opposite to the first movable element;
wherein the first movable element and the second movable element are spaced by the slit.

3. The measurement device according to claim 1, wherein in a n^{th} scanning step, the width of the slit along the first axis is determined using formulas (2) to (3), and the formulas (2) and (3) are applicable to a case of n≥2;
$${h}_{n} = L \cdot tan ( Δθ \times n ) ; \qquad ( 2 )$$
$$Δ {h}_{n} = {h}_{n} - {h}_{n - 1} ; \qquad ( 3 )$$
wherein hₙ represents a stroke height of the slit during the n^{th} scanning step, and Δhₙ represents the width of the slit in the n^{th} scanning step.

4. The measurement device according to claim 1, wherein the step angle Δθ is less than or equal to 0.2 degrees.

5. The measurement device according to claim 1, wherein the thickness of the target ultrathin film ranges between 0.2 nanometers and 2 nanometers.

6. The measurement device according to claim 1, wherein the excitation radiation comprises an X-ray beam or an electron beam.

7. A measurement method for measuring a thickness of an target ultrathin film on a substrate, and the measurement method comprising:
projecting an excitation radiation toward an upper surface of the target ultrathin film at an incident angle, wherein the excitation radiation excites a fluorescence X-ray from the substrate;
adjusting, by an adjustment mechanism of a slit adjustable device, a position of a slit of a slit element along a first axis; and
detecting, by a fluorescence X-ray detector, the fluorescence X-ray that travels through the slit;
wherein the measurement method further comprises:
in a first scanning step, determining, by a controller, a width of the slit along the first axis using formula (1);
$${h}_{1} = Δ {h}_{1} = L \cdot tan ( Δθ ) ; \qquad ( 1 )$$
wherein Δθ represents a step angle, L represents a distance between the slit and the target ultrathin film along a second axis substantially perpendicular to the first axis, h₁ represents a stroke height of the slit during the first scanning step, and Δh₁ represents the width of the slit in the first scanning step.

8. The measurement method according to claim 7, wherein the slit element comprises a first movable element and a second movable element, the second movable element is disposed opposite to the first movable element; the first movable element and the second movable element are spaced by the slit.

9. The measurement method according to claim 7, further comprising:
in a n^{th} scanning step, determining, a controller, a width of the slit along the first axis using formulas (2) to (3), wherein the formulas (2) and (3) are applicable to a case of n≥2;
$${h}_{n} = L \cdot tan ( Δθ \times n ) ; \qquad ( 2 )$$
$$Δ {h}_{n} = {h}_{n} - {h}_{n - 1} ; \qquad ( 3 )$$
wherein hₙ represents a stroke height of the slit during the n^{th} scanning step, and Δhₙ represents the width of the slit in the n^{th} scanning step.

10. The measurement method according to claim 9, wherein the step angle Δθ is less than or equal to 0.2 degrees.

11. The measurement method according to claim 7, wherein the thickness of the target ultrathin film ranges between 0.2 nanometers and 2 nanometers.

12. The measurement method according to claim 7, wherein the excitation radiation comprises an X-ray beam or an electron beam.
